(19) United States
(12) Patent Application Publication
(10) Pub. No.: US 2013/0113322 A1
(43) Pub. Date: May 9, 2013

(54) ELECTROMAGNETIC MODULE AND SPINDLE MOTOR HAVING THE SAME

(71) Applicants: Nam Ki Park, Gyunggi-do (KR); Sang Jae Song, Gyunggi-do (KR)

(72) Inventors: Nam Ki Park, Gyunggi-do (KR); Sang Jae Song, Gyunggi-do (KR)

(73) Assignee: SAMSUNG ELECTRO-MECHANICS CO., LTD., Gyunggi-do (KR)

(21) Appl. No.: 13/401,806

(22) Filed: Feb. 21, 2012

(30) Foreign Application Priority Data
Nov. 9, 2011 (KR) 10-2011-0116603

(51) Int. Cl. H02K 1/27

(52) U.S. Cl. 310/156.04

(57) ABSTRACT

Disclosed herein are an electromagnetic module for a spindle motor including a shaft and a spindle motor having the same. The electromagnetic module includes: an armature including a core and a coil wound around the core; and a magnet facing the armature, wherein the magnet is provided with a protrusion part disposed over the core. The spindle motor includes: a rotor part including a shaft, a hub, and a magnet; a stator part including a sleeve rotatably supporting the shaft, a base having the sleeve coupled thereto, and an armature facing the magnet, fixedly coupled to the base, and including a core and a coil; and a fluid dynamic bearing part formed between the rotor part and the stator part by being filled with oil, wherein the magnet is provided with a protrusion part disposed over the core.

### CROSS REFERENCE TO RELATED APPLICATION

This application claims the benefit of Korean Patent Application No. 10-2011-0116603, filed on Nov. 9, 2011, entitled “Electromagnetic Module and Spindle Motor having the Same”, which is hereby incorporated by reference in its entirety into this application.

### BACKGROUND OF THE INVENTION

1. Technical Field

The present invention relates to an electromagnetic module and a spindle motor having the same.

2. Description of the Related Art

Generally, in a spindle motor used as a driving device of a recording disk such as a hard disk, or the like, a fluid dynamic bearing using dynamic pressure generated by a lubricating fluid such as oil, or the like, stored between a rotor part and a stator part at the time of rotation of the motor, has been widely used.

More specifically, since the spindle motor including the fluid dynamic bearing that maintains shaft rigidity of a shaft only by movable pressure of lubricating oil by centrifugal force is based on centrifugal force, metal friction does not occur and a sense of stability increases as a rotation speed increases, such that the generation of noise and vibration is reduced and a rotating object can be more readily rotated at a high speed than a motor having a ball bearing. As a result, the spindle motor has been mainly applied to a high end optical disk device, a magnetic disk device, or the like.

In addition, in the spindle motor having the fluid dynamic bearing according to the prior art, a pulling plate is mounted on a surface facing the magnet in order to prevent the rotor part from being floated. That is, the floating of the rotor part is prevented by attractive force between the pulling plate and the magnet. However, when the motor rotates, a torque ripple due to a cogging torque occurs. In this case, a ripple also occurs in the magnetic force in an axial direction by the magnetic center.

### SUMMARY OF THE INVENTION

The present invention has been made in an effort to provide an electromagnetic module in which a magnet of a spindle motor is provided with a protrusion part disposed over a core to generate electromagnetic force between the magnet and an armature in an axial direction of a shaft as well as in a radial direction thereof, such that floating of a rotor part may be prevented and a ripple in the magnetic force in the axial direction of the shaft may be reduced, and a spindle motor having the same.

Further, the present invention has been made in an effort to provide a spindle motor that is implemented without a pulling plate, such that magnetic flux loss due to the pulling plate may be reduced, the magnetic force in an axial direction may be stabilized, and a vibration may be reduced.

According to a preferred embodiment of the present invention, there is provided an electromagnetic module for a spindle motor including a shaft, the electromagnetic module including: an armature including a core and a coil wound around the core; and a magnet facing the armature, wherein the magnet is provided with a protrusion part disposed over the core.

The magnet may include: a body part extended in an axial direction of the shaft; and a protrusion part formed at an upper end portion of the body part and extended from the body part toward the armature in a radial direction of the shaft, wherein the protrusion part is disposed over the core.

The body part may be magnetized toward the armature in the radial direction of the shaft and the protrusion part may be magnetized toward the core in the axial direction of the shaft.

The magnetic center of the armature may be disposed at a position equal to or lower than that of the magnetic center of the magnet in the axial direction of the shaft.

The magnetic center of the armature may be disposed at a position lower than that of the magnetic center of the magnet by 0 to 0.5 mm.

According to another preferred embodiment of the present invention, there is provided a spindle motor including: a rotor part including a shaft, a hub, and a magnet; a stator part including a sleeve rotatably supporting the shaft, a base having the sleeve coupled thereto, and an armature facing the magnet, fixedly coupled to the base, and including a core and a coil; and a fluid dynamic bearing part formed between the rotor part and the stator part by being filled with oil, wherein the magnet is provided with a protrusion part disposed over the core.

The magnet may include: a body part extended in an axial direction of the shaft; and a protrusion part formed at an upper end portion of the body part and extended from the body part toward the armature in a radial direction of the shaft, wherein the protrusion part is disposed over the core.

The body part may be magnetized toward the armature in the radial direction of the shaft and the protrusion part may be magnetized toward the core in the axial direction of the shaft.

The rotor part may further include a thrust plate coupled to an upper portion of the shaft and forming a thrust dynamic bearing part with a gap between the thrust plate and the sleeve of the stator part.

The stator part may further include a sealing member coupled to the sleeve and disposed at an upper portion of a thrust plate to thereby form an oil interface.

### BRIEF DESCRIPTION OF THE DRAWINGS

FIG. 1 is a cross-sectional view schematically showing an electromagnetic module according to a preferred embodiment of the present invention;

FIG. 2 is a plan view schematically showing a magnet shown in FIG. 1; and

FIG. 3 is a cross-sectional view schematically showing a spindle motor in which the electromagnetic module according to the preferred embodiment of the present invention is mounted.

### DESCRIPTION OF THE PREFERRED EMBODIMENTS

Various features and advantages of the present invention will be more obvious from the following description with reference to the accompanying drawings.

The terms and words used in the present specification and claims should not be interpreted as being limited to typical meanings or dictionary definitions, but should be interpreted as having meanings and concepts relevant to the technical scope of the present invention based on the rule according to which an inventor can appropriately define the concept of the term to describe most appropriately the best method he or she knows for carrying out the invention.

The above and other objects, features and advantages of the present invention will be more clearly understood from the following detailed description taken in conjunction with the accompanying drawings. In the specification, in adding reference numerals to components throughout the drawings, it is to be noted that like reference numerals designate like components even though components are shown in different drawings. In the description, the terms “first”, “second”, “one surface”, “the other surface” and so on are used to distinguish one element from another element, and the elements are not defined by the above terms. In describing the present invention, a detailed description of related known functions or configurations will be omitted so as not to obscure the gist of the present invention.

Hereinafter, an electromagnetic module and a spindle motor having the same according to preferred embodiments of the present invention will be described in detail with reference to the accompanying drawings.

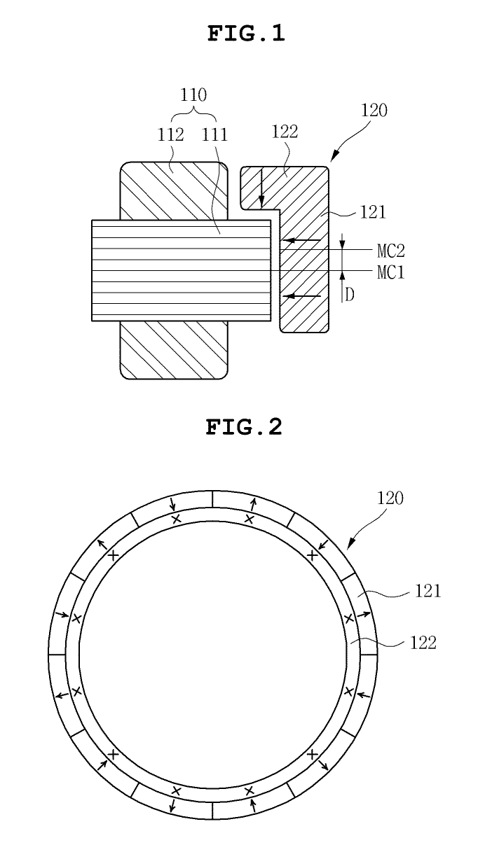

FIG. 1 is a cross-sectional view schematically showing an electromagnetic module according to a preferred embodiment of the present invention; and FIG. 2 is a plan view schematically showing a magnet shown in FIG. 1. As shown, the electromagnetic module, which is an electromagnetic module for a spindle motor including a shaft, includes an armature 110 and a magnet 120 facing the armature 110.

More specifically, the armature 110 includes a core 111 and a coil 112 and is formed by winding the coil 112 around the core 111.

The magnet 120 is formed to have a ring shape and has an inner diameter portion disposed to face the armature 110. In addition, the magnet 120 includes a body part 121 extended in an axial direction of the shaft and a protrusion part 122 extended from the body part 121 toward the armature 110.

Further, the protrusion part 122 is disposed over the core 111 when the electromagnetic module is mounted in the spindle motor. This is to generate electromagnetic force between the magnet 120 and the armature 110 in the axial direction of the shaft as well as in a radial direction thereof as shown by an arrow of FIG. 1 to thereby prevent a rotor part from being floated and reduce a ripple in the magnetic force in the axial direction of the shaft.

In addition, the magnetic center MC1 of the armature 110 may be disposed at a position lower than that of the magnetic center MC2 of the magnet 120 by 0 to 0.5 mm as shown by D in FIG. 1 in the axial direction of the shaft. This is to reduce the ripple in the magnetic force in the axial direction of the shaft.

Further, as shown in FIG. 2, the body part 121 of the magnet 120 is magnetized in the radial direction of the shaft and the protrusion part 122 thereof is magnetized in the axial direction of the shaft in order to generate electromagnetic force in arrow directions of FIG. 1.

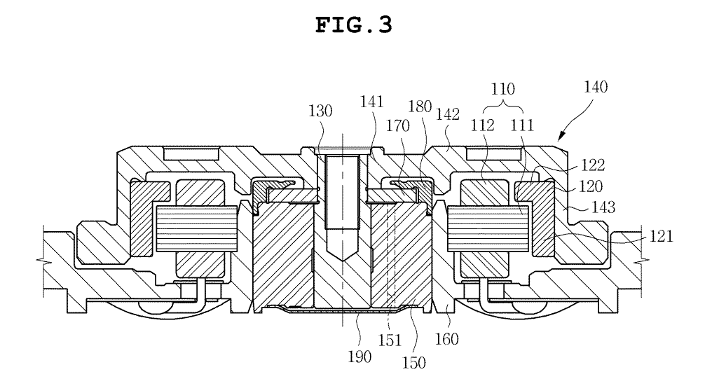

FIG. 3 is a cross-sectional view schematically showing a spindle motor in which the electromagnetic module according to the preferred embodiment of the present invention is mounted. As shown, the spindle motor 100 is configured to include a rotor part including a shaft 130, a hub 140, a magnet 120, and a thrust plate 170; a stator part including a sleeve 150, a base 160, an armature 110, a sealing member 180, and a cover 190; and a fluid dynamic bearing part formed between the rotor part and the stator part by injecting oil, which is working fluid, therebetween.

In the rotor part, the shaft 130 includes the hub 140 coupled to an upper end portion thereof and the thrust plate 170 coupled to an upper portion thereof in order to form a thrust dynamic bearing part with a gap between the thrust plate 170 and the sleeve 150.

In addition, the hub 140 includes a cylindrical part 141 fixed to the upper end portion of the shaft 130, a disk part 142 extended from the cylindrical part 141 in an outer diameter direction, and a sidewall part 143 extended downwardly from an end portion of the disk part 142 in the outer diameter direction in the axial direction of the shaft.

Further, the sidewall part 143 includes an annular ring shaped magnet 120 mounted on an inner peripheral surface thereof so as to face the armature 110 including the core 111 and the coil 112.

In addition, the magnet 120 according to the preferred embodiment of the present invention is formed to have the ring shape, has the inner diameter portion disposed to face the armature 110, and includes the body part 121 extended in the axial direction of the shaft and the protrusion part 122 extended from the body part 121 toward the armature 110, as described above with reference to FIGS. 1 and 2.

Next, in the stator part, the sleeve 150 rotatably supports the shaft 110 and is fixed to the base 160. In addition, the sleeve 150 may have an oil circulation hole 151 formed therein in the axial direction of the shaft 130 so that upper and lower surfaces of the sleeve 150 are connected to each other in order to circulate the oil in a shaft system.

In addition, the sealing member 180 is coupled to an upper portion of the sleeve 150 and is disposed at an upper portion of the thrust plate 170 coupled to the shaft 130 to thereby form an oil interface.

Further, the cover 190, which is to seal the oil injected in order to form the fluid dynamic bearing, is fixed to an inner peripheral surface of a lower end portion of the sleeve 150.

In addition, a radial dynamic bearing part (not shown), which is a fluid dynamic bearing part, is formed between the sleeve 150 and the shaft 130. More specifically, the radial dynamic bearing part is formed by forming a micro clearance between the shaft 130 and the sleeve 150 and filling the oil in the micro clearance.

To this end, the radial dynamic bearing part is formed by selectively forming a dynamic pressure generation groove (not show) in an inner peripheral surface of the sleeve 150 or an outer peripheral surface of the shaft 130 facing the inner peripheral surface of the sleeve 150. In addition, the dynamic pressure generation groove may be selectively formed in pair in upper and lower portions of the inner peripheral surface of the sleeve or in upper and lower portions of the outer peripheral surface of the shaft.

Further, the base 160 includes the armature 110 fixed to an outer peripheral portion thereof by press-fitting, adhesion, or the like, so as to face the magnet 130 and includes the sleeve 150 fixed to an inner peripheral portion thereof by press-fitting, adhesion, or the like, wherein the armature 110 includes the core 111 and the coil 112.

Through the above-mentioned configuration, in the spindle motor according to the preferred embodiment of the present invention, the electromagnetic force is generated between the magnet and the armature in the axial direction of the shaft as well as in the radial direction thereof, thereby making it possible to prevent the rotor part from being floated and reduce the ripple in the magnetic force in the axial direction of the shaft.

As set forth above, according to the preferred embodiments of the present invention, it is possible to provide the electromagnetic module in which the magnet of the spindle motor is provided with the protrusion part disposed over the core to generate the electromagnetic force between the magnet and the armature in the axial direction of the shaft as well as in the radial direction thereof, such that the floating of the rotor part may be prevented and the ripple in the magnetic force in the axial direction of the shaft may be reduced, and the spindle motor having the same. In addition, it is possible to provide a spindle motor that is implemented without a pulling plate, such that magnetic flux loss due to the pulling plate may be reduced, the magnetic force in an axial direction may be stabilized, and a degree of vibration may be reduced.

Although the preferred embodiments of the present invention have been disclosed for illustrative purposes, they are for specifically explaining the present invention and thus an electromagnetic module and a spindle motor having the same according to the present invention are not limited thereto, but those skilled in the art will appreciate that various modifications, additions and substitutions are possible, without departing from the scope and spirit of the invention as disclosed in the accompanying claims.

Accordingly, any and all modifications, variations or equivalent arrangements should be considered to be within the scope of the invention, and the detailed scope of the invention will be disclosed by the accompanying claims.

What is claimed is:

1. An electromagnetic module for a spindle motor including a shaft, the electromagnetic module comprising:
an armature including a core and a coil wound around the core; and
a magnet facing the armature,
wherein the magnet is provided with a protrusion part disposed over the core.

2. The electromagnetic module as set forth in claim 1, wherein the magnet includes:
a body part extended in an axial direction of the shaft; and
a protrusion part formed at an upper end portion of the body part and extended from the body part toward the armature in a radial direction of the shaft, the protrusion part being disposed over the core.

3. The electromagnetic module as set forth in claim 2, wherein the body part is magnetized toward the armature in the radial direction of the shaft and the protrusion part is magnetized toward the core in the axial direction of the shaft.

4. The electromagnetic module as set forth in claim 1, wherein the magnetic center of the armature is disposed at a position equal to or lower than that of the magnetic center of the magnet in the axial direction of the shaft.

5. The electromagnetic module as set forth in claim 4, wherein the magnetic center of the armature is disposed at a position lower than that of the magnetic center of the magnet by 0 to 0.5 mm.

6. A spindle motor comprising:
a rotor part including a shaft, a hub, and a magnet;
a stator part including a sleeve rotatably supporting the shaft, a base having the sleeve coupled thereto, and an armature facing the magnet, fixedly coupled to the base, and including a core and a coil; and
a fluid dynamic bearing part formed between the rotor part and the stator part by being filled with oil,
wherein the magnet is provided with a protrusion part disposed over the core.

7. The spindle motor as set forth in claim 6, wherein the magnet includes:
a body part extended in an axial direction of the shaft; and
a protrusion part formed at an upper end portion of the body part and extended from the body part toward the armature in a radial direction of the shaft, the protrusion part being disposed over the core.

8. The spindle motor as set forth in claim 7, wherein the body part is magnetized toward the armature in the radial direction of the shaft and the protrusion part is magnetized toward the core in the axial direction of the shaft.

9. The spindle motor as set forth in claim 6, wherein the rotor part further includes a thrust plate coupled to an upper portion of the shaft and forming a thrust dynamic bearing part with a gap between the thrust plate and the sleeve of the stator part.

10. The spindle motor as set forth in claim 6, wherein the stator part further includes a sealing member coupled to the sleeve and disposed at an upper portion of a thrust plate to thereby form an oil interface.
